(19) United States
(12) Patent Application Publication
(10) Pub. No.: US 2024/0346898 A1
(43) Pub. Date: Oct. 17, 2024

(54) METHODS AND APPARATUSES FOR MOUNTING AND SERVICING ELECTRONIC SURVEILLANCE EQUIPMENT

(71) Applicant: ArmorForge, LLC, Punta Gorda, FL (US)

(72) Inventor: Dan Pearson, Punta Gorda, FL (US)

(21) Appl. No.: 18/633,374

(22) Filed: Apr. 11, 2024

Related U.S. Application Data
(60) Provisional application No. 63/495,502, filed on Apr. 11, 2023.

(51) Int. Cl. G08B 13/196

(52) U.S. Cl. CPC G08B 13/19632; G08B 13/19619; G08B 13/1963

(57) ABSTRACT

Disclosed herein is an apparatus that includes a base and a first arm. The first arm is pivotally coupled to the base and pivotable with respect to the base about a first axis at a first end of the first arm. The apparatus further includes a second arm pivotally coupled to the first arm at a second end of the first arm. The apparatus additionally includes a third arm rotatably coupled to the second arm and rotatable with respect to the second arm about a second axis substantially perpendicular to the first axis, the third arm including an equipment-engagement feature configured to receive electronic equipment.

### FIELD

This disclosure relates generally to electronic surveillance equipment, and more particularly to mounting and servicing electronic surveillance equipment.

### BACKGROUND

Wall-mounted electronic surveillance equipment is mounted to large structures (e.g., houses, buildings, and the like) to promote security in and around such structures. For example, parapet-mounted video cameras can provide a view of the structure and/or the surroundings of the structure from a location exterior to the structure. Such equipment is serviced and/or replaced periodically to ensure continued function.

### SUMMARY

The subject matter of the present application has been developed in response to the present state of the art, and in particular, in response to the shortcomings of conventional methods and apparatuses for mounting and servicing electronic surveillance equipment that is mounted to a wall, which have not yet been fully solved by currently available techniques. Some conventional methods and apparatuses include use of a high-profile, goose neck, mount, which can be unstable in certain weather conditions (e.g., windy conditions), be highly conspicuous, and require an operator to at least partially lean over the wall, to which the mount is attached, in order to service the equipment. The subject matter of the present application has been developed to provide methods and apparatuses for mounting and servicing electronic surveillance equipment that overcome at least some of the above-discussed shortcomings of prior art techniques.

Disclosed herein is an apparatus. The apparatus includes a base. The apparatus also includes a first arm pivotally coupled to the base and pivotable with respect to the base about a first axis at a first end of the first arm. The apparatus further includes a second arm pivotally coupled to the first arm at a second end of the first arm. The apparatus additionally includes a third arm rotatably coupled to the second arm and rotatable with respect to the second arm about a second axis substantially perpendicular to the first axis, the third arm including an equipment-engagement feature configured to receive electronic equipment. The preceding subject matter of this paragraph characterizes example 1 of the present disclosure.

The equipment-engagement feature of the third arm is positioned at a distal end portion of the third arm. The preceding subject matter of this paragraph characterizes example 2 of the present disclosure, wherein example 2 also includes the subject matter according to example 1, above.

The second axis passes through a midpoint of second arm. The preceding subject matter of this paragraph characterizes example 3 of the present disclosure, wherein example 3 also includes the subject matter according to any of examples 1-2, above.

The electronic equipment includes an electrical surveillance device. The preceding subject matter of this paragraph characterizes example 4 of the present disclosure, wherein example 4 also includes the subject matter according to any of examples 1-3, above.

The base includes one or more slots configured to receive one or more mounting brackets and is configured to be secured to a wall via the one or more attachment members. The preceding subject matter of this paragraph characterizes example 5 of the present disclosure, wherein example 5 also includes the subject matter according to any of examples 1-4, above.

The second arm, the third arm, and the second end of the first arm are configured to move with respect to the base in a first plane. The preceding subject matter of this paragraph characterizes example 6 of the present disclosure, wherein example 6 also includes the subject matter according to any of examples 1-4, above.

The second arm, the third arm, and the second end of the first arm are configured to move with respect to the base in a second plane substantially perpendicular to the first plane. The preceding subject matter of this paragraph characterizes example 7 of the present disclosure, wherein example 7 also includes the subject matter according to example 6, above.

The apparatus further includes a fourth arm. The fourth arm is substantially parallel to the first arm, pivotally coupled to the base, pivotable with respect to the base about a first axis at a first end of the fourth arm, and coupled to the second arm at a second end of the fourth arm. The preceding subject matter of this paragraph characterizes example 8 of the present disclosure, wherein example 8 also includes the subject matter according to any of examples 1-7, above.

The apparatus further includes a fifth arm. The fifth arm is substantially parallel to the first arm, pivotally coupled to the base, pivotable with respect to the base about a first axis at a first end of the fifth arm, and coupled to the second arm at a second end of the fifth arm. The preceding subject matter of this paragraph characterizes example 9 of the present disclosure, wherein example 9 also includes the subject matter according to any of examples 1-8, above.

A length of the second arm is less than a length of the third arm. The preceding subject matter of this paragraph characterizes example 10 of the present disclosure, wherein example 10 also includes the subject matter according to any of examples 1-9, above.

The base includes a portion configured to receive the second arm. The preceding subject matter of this paragraph characterizes example 11 of the present disclosure, wherein example 11 also includes the subject matter according to any of examples 1-10, above.

The number of attachment members extend substantially perpendicular to the base in the first plane and are configured to attach to a wall. The preceding subject matter of this paragraph characterizes example 12 of the present disclosure, wherein example 12 also includes the subject matter according to any of examples 5-10, above.

The number of attachment members are attached to a first side of the base, the first side of the base being opposite to a second side of the base to which the first arm is pivotally coupled. The preceding subject matter of this paragraph characterizes example 13 of the present disclosure, wherein example 13 also includes the subject matter according to example 12, above.

The number of attachment members including a first attachment member configured to attach to a first wall segment and a second attachment member configured to attach to a second wall segment substantially perpendicular to the first wall segment. The preceding subject matter of this paragraph characterizes example 14 of the present disclosure, wherein example 14 also includes the subject matter according to any of examples 12-13, above.

Further disclosed herein is a method of mounting electronic equipment to barriers. The method of mounting electronic equipment to barriers includes attaching the electronic equipment to a distal end of a first arm. The method of mounting electronic equipment to barriers also includes rotating a first arm with respect to a second arm about a first axis. The method of mounting electronic equipment to barriers further includes moving the first arm and the second arm in a first plane substantially parallel to the first axis via a third arm until the third arm is substantially parallel to a base. The third arm is coupled to the second arm at a first end and pivotally coupled to the base at a second end. The preceding subject matter of this paragraph characterizes example 15 of the present disclosure.

Attaching the electronic equipment to the distal end of the first arm further includes attaching the electronic equipment to an equipment-engagement feature positioned on a side of the first arm facing the second arm. The preceding subject matter of this paragraph characterizes example 16 of the present disclosure, wherein example 16 also includes the subject matter according to example 15, above.

Attaching the electrical device to the distal end of the first arm further includes rotating the electronic equipment about a second axis substantially parallel to the first axis. The preceding subject matter of this paragraph characterizes example 17 of the present disclosure, wherein example 17 also includes the subject matter according to any of examples 15-16, above.

The electrical device extends below the base when the first arm is substantially parallel to the base. The preceding subject matter of this paragraph characterizes example 18 of the present disclosure, wherein example 18 also includes the subject matter according to any of examples 15-17, above.

The method further includes attaching the base to a top of a wall segment. The preceding subject matter of this paragraph characterizes example 19 of the present disclosure, wherein example 19 also includes the subject matter according to any of examples 15-18, above.

Additionally disclosed herein is a method of servicing mounted electronic equipment, including moving a top arm and a middle arm of an apparatus in a first plane with respect to a base of the apparatus by rotating a pivot arm of an apparatus with respect to a base of the apparatus around a first axis until the electronic equipment is above of a top side of a barrier to which the base is attached. The first plane is substantially perpendicular to the top side of the barrier. The method of servicing mounted electronic equipment also includes rotating the top arm with respect to the middle arm about a second axis substantially perpendicular to the first axis. The preceding subject matter of this paragraph characterizes example 20 of the present disclosure.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1A is a side view of an apparatus in a deployed state, according to one or more examples of the present disclosure;

FIG. 1B is a side view of an apparatus in a transition state between a deployed state and a servicing state, according to one or more examples of the present disclosure;

FIG. 1C is a side view of an apparatus in a first servicing state, according to one or more examples of the present disclosure;

FIG. 1D is a side view of an apparatus in a transition state between a first servicing state and a second servicing state, according to one or more examples of the present disclosure;

FIG. 1E is a side view of an apparatus in a second servicing state, according to one or more examples of the present disclosure;

FIG. 2A is a perspective view of an apparatus in a deployed state, according to one or more examples of the present disclosure;

FIG. 2B is a perspective view of an apparatus in a first servicing state, according to one or more examples of the present disclosure;

FIG. 2C is a perspective view of an apparatus in a second servicing state, according to one or more examples of the present disclosure;

FIG. 3A is an underside perspective view of a portion of an apparatus for attaching electronic equipment, according to one or more embodiments of the present disclosure;

FIG. 3B is a perspective view of a portion of an apparatus for attaching electronic equipment, according to one or more embodiments of the present disclosure;

FIG. 4A is a side view of an apparatus mounted to a wall having a first thickness, according to one or more embodiments of the present disclosure;

FIG. 4B is a side view of an apparatus mounted to a wall having a second thickness, according to one or more embodiments of the present disclosure;

FIG. 5A is a top plan view of an apparatus mounted to a corner of a wall, according to one or more embodiments of the present disclosure;

FIG. 5B is an underside perspective view of an apparatus mounted to a corner of the wall, according to one or more embodiments of the present disclosure;

FIG. 6A is a top plan view of an apparatus, according to one or more embodiments of the present disclosure; and

FIG. 6B is a close-up, top plan view of an apparatus, according to one or more embodiments of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

In many instances, electronic surveillance equipment is located in areas that are difficult to access, such as near the top of an exterior wall or barrier of a building. Accordingly, wall-mounted equipment, such as wall-mounted electronic surveillance equipment, can be difficult to service and install safely and efficiently using conventional methods and mounts. Moreover, conventional mounts are unstable, conspicuous, and high profiled. Embodiments of the present disclosure include streamlined and low-profiled apparatuses for mounting equipment to walls. Moreover, embodiments of the present disclosure allow for more flexibility in repositioning the wall-mounted equipment, relative to the wall, during servicing and installation, which promotes convenience and safety. For example, embodiments of the present disclosure facilitate installation and servicing from a safer side of a wall.

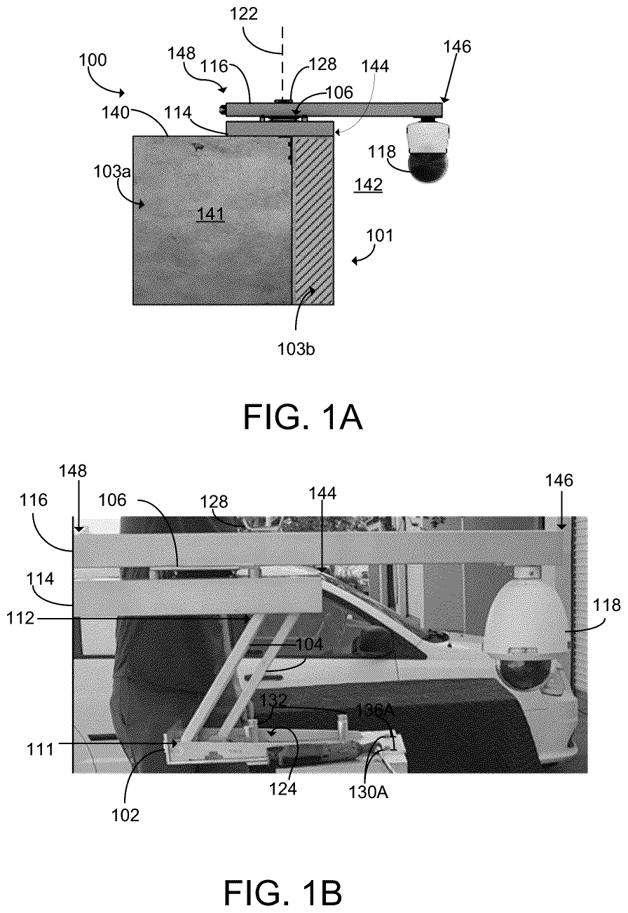

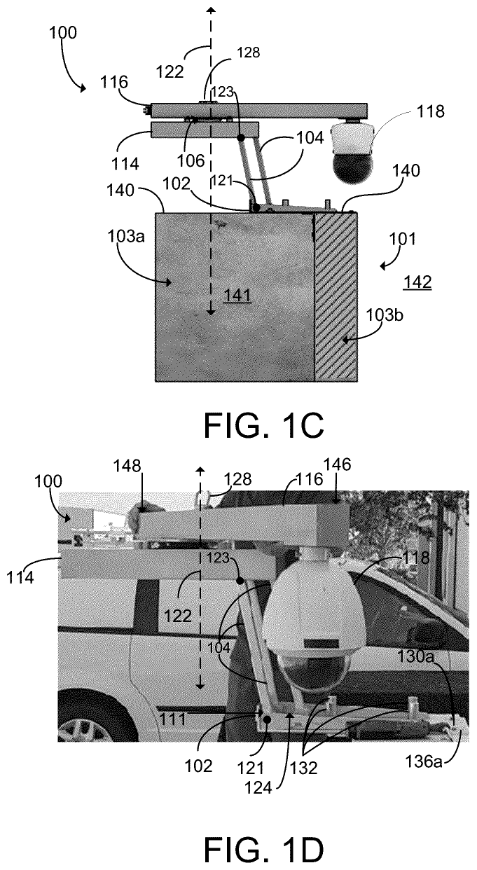

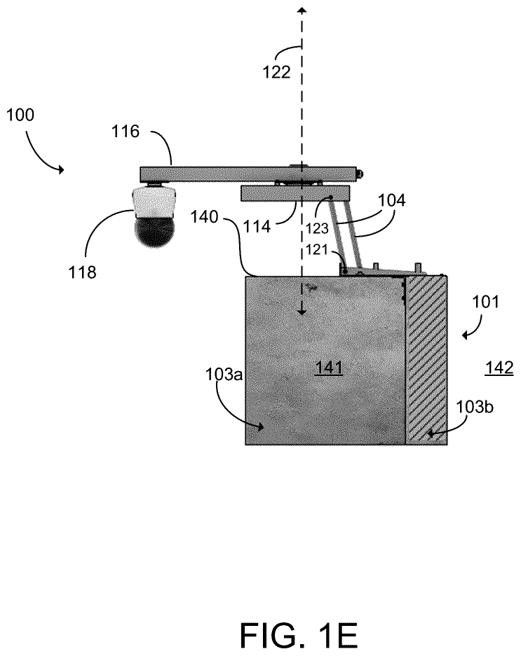

As illustrated in FIG. 1A, embodiments of the present disclosure include an apparatus 100. The apparatus 100 is configured to be attached to a barrier 101 of a structure, which can be a building. For example, in some embodiments, the barrier 101 includes a wall (e.g., a parapet) around a secured area 141, and the apparatus 100 is configured to mount electronic equipment 118 to and/or maneuver the electronic equipment 118 relative to the wall. The electronic equipment 118 can be any of various types of electronic equipment, without limitation, such as electronic surveillance equipment (e.g., security cameras, infrared sensors, motion sensors, audio devices, visual devices, and the like). FIG. 1A shows the apparatus 100 in a deployed state. In other words, FIG. 1A shows the apparatus 100 in a state in which the electronic equipment 118, secured to the apparatus 100, is in use, or is in a usable state, and not being serviced. For example, the electronic equipment 118 includes a security camera, and the security camera is positioned to survey an exterior of the barrier 101 and/or the surroundings of the barrier 101 when in the deployed state.

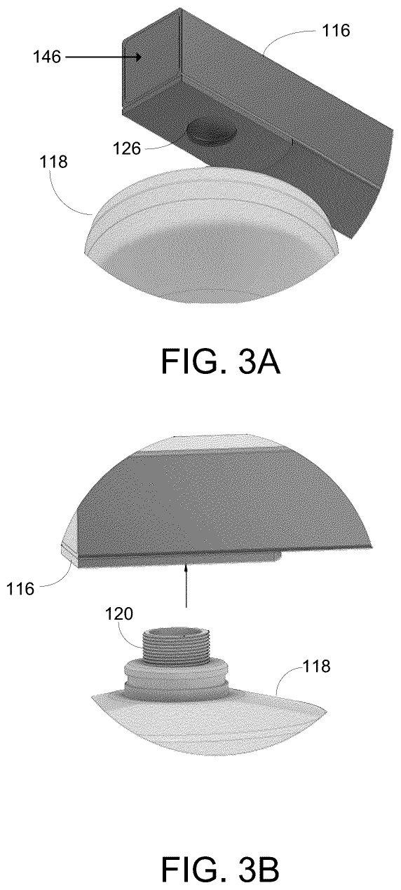

As shown in FIG. 1B, the apparatus 100 includes a base 102 and a number of arms each coupled directly or indirectly to the base 102. As shown in FIG. 1A, the arms of the apparatus 100 include a top arm 116, which has a distal end portion 146 configured to receive the electronic equipment 118 (also see, e.g., FIGS. 3A and 3B). As illustrated in FIG. 1A, in some examples, when the apparatus 100 is in the deployed state, the electronic equipment 118 is located below a top side 140 of the barrier 101. Such a low profile configuration helps to ease spatial constraints, improve stability, and reduce the risk of the electronic equipment 118 being damaged by environmental elements, such as wind, when the apparatus 100 is deployed and the electronic equipment 118 is operational. However, when service or replacement of the electronic equipment 118 is needed, the electronic equipment 118 can be moved up, from the exterior 142, and around the barrier 101. Embodiments of apparatuses and methods for achieving the latter are described herein.

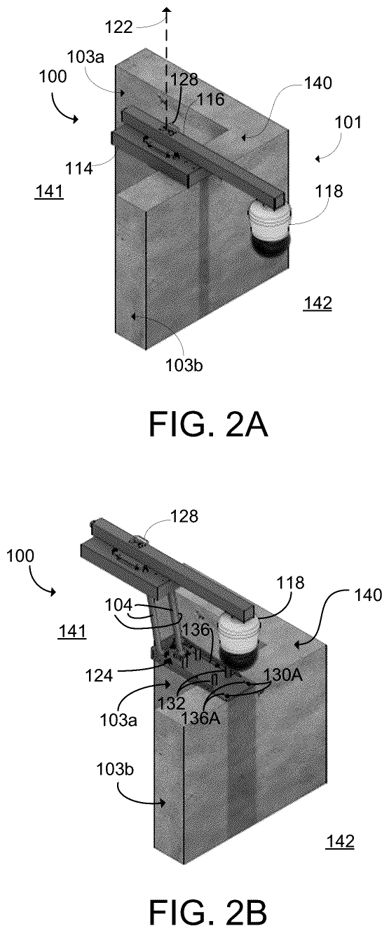

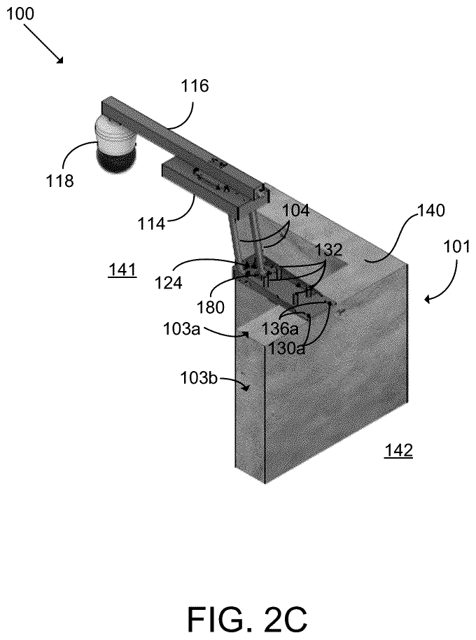

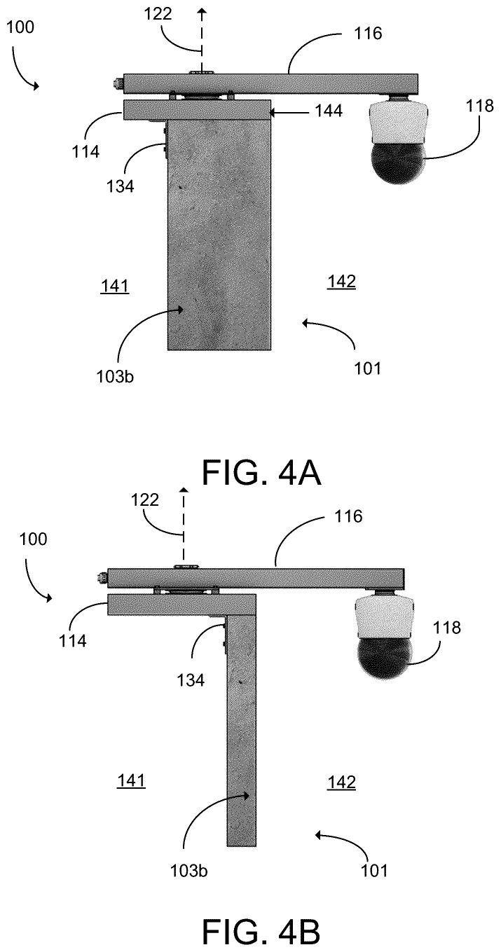

The base 102 is mounted directly to the barrier 101 in some examples. For example, as illustrated in FIG. 2B, the base 102 is mounted directly to the top side 140 of the barrier 101. In some embodiments, as shown, the base 102 is mounted to the top side 140 of the wall 103 so that the base 102 extends lengthwise along a thickness of the wall 103, as shown in FIGS. 2A, 2B, 4A, and 4B. In some examples, the length of the base 102 and/or of the middle arm 114 is greater than the thickness of the wall 103 such that a portion of the base 102 overhangs an interior surface of the wall 103 and extends into the secured area 141. For example, as shown in FIGS. 4A, the middle arm 114, which covers the base, extends beyond the thickness of the wall 103. In some embodiments, the length of the middle arm 114 is longer than the length of the base 102.

Although not shown in the figures, in some examples, the base 102 is mounted to the top of the wall 103 so that the base 102 extends lengthwise along a length of the wall 103. In such examples, the base 102 does not overhang the interior surface of the wall 103. In some examples, the base 102 is mounted flush with and substantially parallel to the top side 140 of the wall 103.

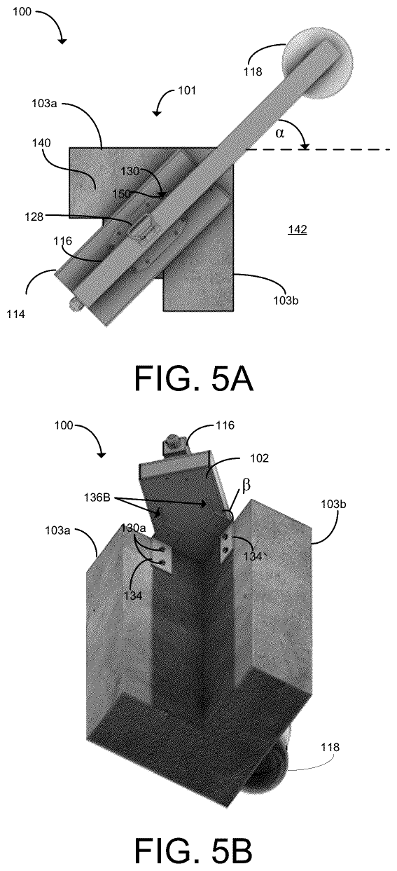

In certain examples, as explained in more detail below, the base 102 can span a portion of multiple walls (see, e.g., walls 103a and 103b in FIGS. 5A and 5B, which form a corner of the barrier 101). For example, as shown in FIGS. 5A and 5B, the base 102 is mounted to two joining (e.g., angled) portions of the barrier 101. In other words, the base 102 is attached to both walls 103a and 103b of the barrier 101. However, as illustrated in FIGS. 2A-2C, the base 102 can be mounted to only one of multiple adjoining walls, such as the walls 103a and 103b. In FIGS. 1A-2C, the base 102 is mounted only to the wall 103a of the barrier 101.

Based on the foregoing, the base 102 is configured to enable the apparatus 100 to be mounted to walls 103 of the barrier 101 in any of various orientations and configurations.

As illustrated in FIGS. 2B and 5B, the base 102 includes one or more pairs of slots. In one example, the base 102 includes a pair of wall slots 136A and a pair of bracket slots 136B. The base 102 is partially secured to the wall by passing fasteners 130a through the pair of wall slots 136A and anchoring the fasteners 130a into the wall, as illustrated in FIG. 2B. In contrast, although not shown in FIG. 5B, in some embodiments, the base 102 is further secured to the wall by passing fasteners through an aperture of a corresponding bracket 134, through a corresponding one of the pair of bracket slots 136B, and anchoring the fasteners to the base, such as via a nut. Then, separate fasteners 130b are passed through corresponding holes in the brackets and anchored into the wall. In some examples, the mounting brackets 134 are 90° metal connections or joined metal plates that are substantially perpendicular to each other (e.g., elbow joints).

Because the fasteners are allowed to slide within the slots (or vice versa), the position of the fasteners relative to the slots, and thus the position of the base 102 relative to wall 103, is adjustable, which promotes flexibility when mounting the apparatus 100 to walls of different shapes, sizes, and configurations. For example, the apparatus 100 can be adjusted to accommodate barriers 101 of different thicknesses. For example, FIG. 4A shows a wall 103 with a thickness. The apparatus 100 includes mounting brackets 134 assembled in the base 102 such that the distal edge 144 of the middle arm 114 remains flush with the exterior 142 of the wall 103. FIG. 4B shows the apparatus 100 mounted to a wall 103 with a lesser thickness. However, since the mounting brackets 134 can be moved further along the slot 136B of the base 102, the apparatus 100 accommodates the reduced thickness while maintaining the distal edge 144 of the middle arm 114 substantially flush with the exterior 142 of the wall 103.

The slots 136B of the base 102 allow the mounting brackets 134 to be positioned at corresponding angles. For example, a corner of the mounting bracket 134 remains within the slot 136B, while another corner of the mounting bracket 134 is outside of the slot and/or positioned within a different slot 136B of the base 102. For example, FIG. 5B is an underside view of the base 102 in a deployed position at a corner of a barrier 101. FIG. 5A is a top view of the base 102 in the same or similar deployed position. As shown in FIGS. 5A and 5B, the electronic equipment 118 is deployed at a corner 101 of a barrier (e.g., where two walls 103a and 103b meet). For example, the apparatus 100 is deployed at an angle α outward from the corner of the barrier 101. For example, the angle α is approximately 45°. This is facilitated by each mounting brackets 134 being positioned at an angle β with respect to the base 102.

In some embodiments, portions of the mounting brackets 134 extend substantially perpendicular to the base 102 on the side opposite to the side that the pivot arms 104 are attached to. The mounting brackets 134 are configured to attach the base 102 to segments 103a and 103b of the barrier 101. For example, as illustrated in FIG. 5B, each mounting bracket 134 is attached to a different one of the walls 103a and 103b. As mentioned above, the walls 103a and 103b are substantially perpendicular to each other and meet to form a corner of the barrier 101.

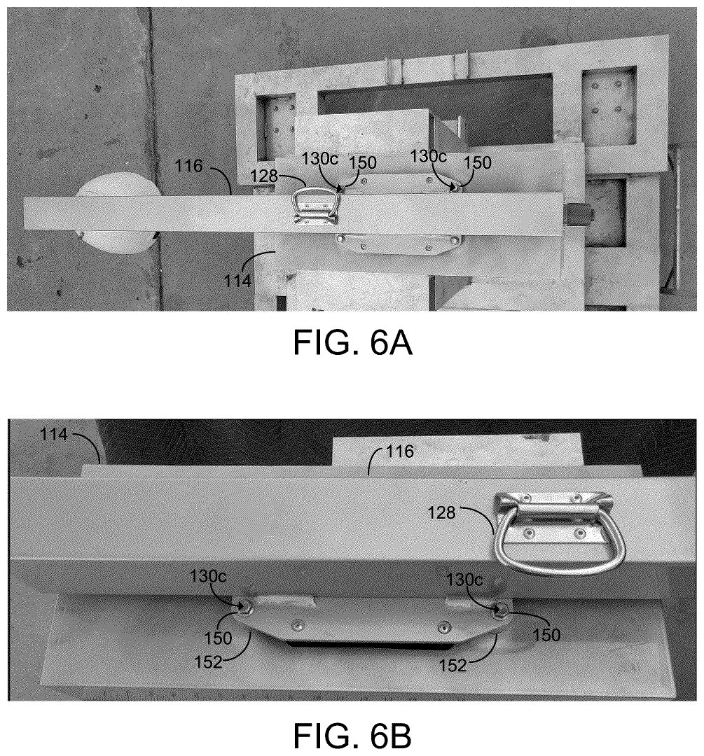

In some embodiments, the base 102 has dimensions and the middle arm 114 has an inverted U-shaped cross-section, such that the base 102 fits within the middle arm 114 of the apparatus 100, and obscures the base 102 from view, when the apparatus 100 is in the deployed state. In other words, a thickness of at least some portions of the base 102 is less than a thickness of the middle arm 114. The middle arm 114, with its inverted U-shaped cross-section, also includes a cavity for receiving the base 102. The cavity enables the middle arm 114 to cover the base 102 when the apparatus 100 is in the deployed position. In some examples, the base 102 further includes one or more receptacles 132, as shown in FIG. 1B. In certain examples, the base 102 includes four receptacles 132. Each one of the receptacles 132 is configured to receive a corresponding fastener 130c (see, e.g., FIG. 6A). The fasteners 130c secure various arms of the apparatus 100 to each other, to the base 102, and/or to the barrier 101. As shown in FIG. 6B, when the apparatus 100 is in the deployed state, the fasteners 130c are passable through corresponding openings 150 formed in the top arm 116, pass through corresponding openings 152 formed in the middle arm 114, and engage corresponding receptacles 132 to secure the top arm 116 to the middle arm 114 and to secure the middle arm 114 to the base 102. In this manner, engagement between the fasteners 130c and the receptacles 132 fixes together the top arm 116, the middle arm 114, and the base 102 so that the top arm 116, the middle arm 114, and the base 102 do not move relative to each other when the apparatus 100 is in the deployed state, as shown in FIG. 1A. When the fasteners 130c are disengaged from the receptacles 132, the top arm 116, the middle arm 114, and the base 102 are movable with respect to each other. For example, as described in more detail below, the middle arm 114 is liftable up and away from the base 102. Even when the fasteners 130c are disengaged, the top arm 116 is still secured to the middle arm 114 but pivotable with respect to the middle arm 114 about a third axis 122. The top arm 116 moves up and away from the base 102 when the middle arm 114 moves up and away from the base.

As shown in FIG. 1C, the apparatus 100 includes at least one pivot arm 104 pivotally coupled to the base 102 at a first end 111 of the at least one pivot arm 104, and pivotable with respect to the base 104 about a first axis 121 into the page. Similarly, the pivot arm 104 is pivotally coupled to the middle arm 114 (e.g., via a pivot pin (not shown)) at a second end 112 of the pivot arm 104 opposite the first end 111 of the pivot arm 104. The pivot arm 104 is pivotable with respect to the middle arm 114 about a second axis 123 into the page. Pivoting of the pivot arm 104 relative to the base 102 and the middle arm 114, and thus the electronic equipment 118, to be lifted up and over the barrier 101 for servicing and/or installation. If the barrier 101 is a parapet, for example, a technician could service the electronic equipment 118 by standing on the roof and bringing the electronic equipment 118 up, from the exterior 142, over the barrier 101, and towards them. This method helps to improve safety and efficiency compared to servicing the electronic equipment 118 from the exterior 142 of the barrier 101, which could require the technician to use a ladder and/or tether themselves to the barrier 101 to access the electronic equipment.

As shown in FIG. 6A, in some examples, the apparatus 100 includes a handle 128 positioned on the top arm 116. The handle 128 can be pulled upward (i.e., in a direction away from the base 102) to initiate movement of the top arm 116 and middle 114 in the first plane and, hence, pivoting of the pivot arm(s) 104 about the first axis 121. Some examples include applying torque to the handle 128 to initiate rotation of the top arm 116 with respect to the pivot arm 114. For example, this application of torque moves the electrical equipment from an exterior 142 of the barrier 101, over the wall 103b, and towards the interior 141 of the barrier 101, as shown in FIGS. 1A-D. Although examples of the present disclosure include mechanically moving the upper arm 116 up and over the barrier 101, examples of the present disclosure are not so limited. Examples of the present disclosure also include any movements described herein as being actuated electronically. In some embodiments, such movements are automated via one or more motors, actuators, and the like.

The pivot arm 104 moves with respect to the base 102 in a first plane (i.e., about the first axis 121, which is perpendicular to the first plane and parallel with the mounting surface of the base 102). Referring to FIG. 2C, the pivot arm 104, in some embodiments, is pivotally coupled directly to the base 102 via a pivot pin 180 that defines the first axis 121 and to the middle arm 114 via a pivot pin that defines the second axis 123. The first axis 121 is parallel to the second axis 123. For example, the base 102 can include a pair of tabs, which retain the pivot pin GGG in place and between which the bottom end of the pivot arm 104 is located and allowed to pivot. Similarly, although not shown, the middle arm 114 can include a pair of tabs, which retain a pivot pin in place and between which the top end of the pivot arm 104 is located and allowed to pivot. In some embodiments, the first axis 121 and the second axis 123 are substantially parallel to a top side 140 of the barrier 101 when the base 102 is mounted to the top side 140 of the barrier 101. The first axis 121, the second axis 123, and the pivot arm(s) 104 enable the apparatus 100 to pivot the mounted electronic equipment 118 up out of the deployed state, and down into the deployed state. In some embodiments, in the deployed state, the electronic equipment 118 extends below the top side 140 of the wall 103b. Movement through the axis 121 via the pivot arm(s) 104 allows the electronic equipment 118 to be brought up above the barrier 101.

In some examples, as illustrated in FIG. 1E, the apparatus 100 includes multiple pivot arms 104 between and coupling together the middle arm 114 and the base 102. For example, in the illustrated example in FIG. 2B, the apparatus 100 includes three pivot arms 104. In some examples, the three pivot arms 104 include two pivot arms where their first axes 121 are colinear and their second axes 123 are colinear, and one pivot arm where it first axis 121 and its second axis 123 is parallel to, but offset from, the first axes 121 and the second axes 123 of the two pivot arms. In this manner, one of the pivot arms 104 is staggered along a length of the base 102 or the middle 114 relative to the other two pivot arms. Having multiple pivot arms 104 helps to increase overall stability, particularly when the apparatus 100 is in a servicing position, such as the position shown in FIG. 1E.

In the servicing state or position, the pivot arms 104 are locked into place, such that the apparatus 100 remains in position while servicing. Although not pictured, some examples of the present disclosure include stops, coupled to the base 102 and/or the middle arm 114, which contact and support the pivot arms 104 in place when brought into the servicing position. Alternatively, in some examples, the base 102 includes an end plate, and the middle arm 114 includes an end plate, that acts as a stop to keep the apparatus 100 in place when it is in a servicing position.

The base 102 is configured such that the pivot arms 104 pivot into and are concealed by the base 102 in the deployed state. For example, as shown in FIG. 1B, the base 102 includes a cavity 124 that receives and at least partially conceals the pivot arms 104 when in the deployed state.

In addition to the pivot arm(s) 104, the number of arms of the apparatus 100 further includes the middle arm 114 and the top arm 116. The middle arm 114 is coupled to the pivot arm 104 at a second end 112 of the pivot arm 104, or the end 112 opposite to the end 111 that is secured to the base 102. The middle arm 114 remains substantially parallel to the top 140 of the barrier 101, when the base is mounted to the top 140 of the barrier 101, and to the top arm 116 as the apparatus 100 moves from a deployed to a servicing configuration. Although examples of the present disclosure include a middle arm 114 coupled to the top arm 116, examples of the present disclosure are not so limited. For example, in some examples, the top arm 116 is coupled directly to one of the pivot arms 104 at the second end 112 of the pivot arm 104 and is pivotable around an axis substantially perpendicular to the first axis 121, or substantially parallel to the third axis 123.

The top arm 116 is rotatably coupled to the middle arm 114 and rotatable with respect to the middle arm 114 about the third axis 122. For example, the top arm 116 is rotatably coupled to the middle arm 114 via a coupling 106 of the apparatus 100. The coupling 106 can be any of various mechanisms that facilitate rotation of the top arm 116 relative to the middle arm 114, such as, but not limited to, a swivel, a bearing, a pin, and a pivot.

As shown in FIG. 1C, the third axis 122 is substantially perpendicular to the first axis 121 and to the second axis 123. This allows the electronic equipment 118 to be rotated relative to the middle arm 114 from the first servicing state, shown in FIG. 1C, to the second servicing state, shown in FIG. 1E. As shown in FIG. 1E, in the second servicing state, the electronic equipment 118 is on the interior 141 of the barrier 101. This can make the electronic equipment 118 much easier to access, especially if the barrier 101 is a parapet on a roof and the electronic equipment 118 is rotated to the interior 141, which is a roof side of the parapet.

In some embodiments, the top arm 116 is configured to rotate up to 360° with respect to the middle arm 114. In some embodiments, while the top arm 116 rotates about the third axis 122, the middle arm 114 can remain stationary with respect to the pivot arm 104. In other embodiments, the middle arm 114 can be pivoted with respect to the pivot arm 104 about the second axis 123 while the top arm 116 is rotated about the third axis 122.

In some embodiments, the top arm 116 is longer than the middle arm 114. The top arm 116 is also longer than the base 102. In this manner, the top arm 114 acts boom arm that terminates at a location well away from the barrier 101 when the apparatus 100 is in the deployed state. This allows the electronic equipment 118 to hang exteriorly over the edge of the barrier 101, when the apparatus 100 is in the deployed state, and interiorly within the barrier 101 when the apparatus 100 is in the servicing state.

FIG. 1D shows a transition state between the first servicing state shown in FIG. 1C and the second servicing state shown in FIG. 1E, according to various embodiments. In some embodiments, the electronic equipment 118 can be serviced when the apparatus 100 is in the first servicing state, shown in FIG. 1E, or in the transition state if desired. However, in other embodiments, it is preferable to bring the electronic equipment 118 to another side of the barrier 101 for servicing, such as the interior 141, by positioning the apparatus 100 into the second servicing state. FIG. 1D shows the top arm 116 being rotated with respect to the middle arm 114. As shown in FIG. 1D, force is applied manually to a proximal end 148 of the top arm 116, or an end of the top arm 116 opposite of the electronic equipment 118 and at which the technician is standing, to rotate the top arm 116. Although the top arm 116 is configured to rotate up to 360°,examples of the present disclosure include rotating the top arm 116 approximately 180° for servicing. In other examples, the top arm 116 is rotated approximately 90°.

The top arm 116 includes an equipment-engagement feature 126 configured to receive and retain the electronic equipment 118. The equipment-engagement feature 126 is located at a distal end portion 146 of the top arm 116. For example, FIG. 3A shows an underside view, which depicts the equipment-engagement feature 126 being formed in an underside surface of the distal end portion 146 of the top arm 116. In some examples, the equipment-engaged feature 126 is shaped to receive a portion 120 of the electronic equipment 118 (see, e.g., FIGS. 3A and 3B). In some examples, the portion 120 of the electronic equipment 118 includes threads and the equipment-engagement features 126 includes corresponding threads. The threads of the electronic equipment 118 can be threadably engaged with the threads of the engagement portion 120 to secure the electronic equipment 118 to the engagement portion 120. As mentioned, the equipment-engagement feature 126 of the top arm 116 is positioned at the distal end portion 146 of the top arm 116. Because the distal end portion 146 is located furthest away from the wall 103b when the apparatus 100 is in the deployed state, the equipment 118 is correspondingly located away from the wall 103b.

In some examples, the top arm 116 moves with respect to the base 102 along both a first plane, perpendicular to the base 102, as shown in FIG. 1B (i.e., via pivoting of the pivot arm 104 around the first axis 121 and the second axis 123), and in a second plane, perpendicular to the first plane and parallel to the base 102, as shown in FIG. 1E (i.e., via rotation of the top arm 116 about the third axis 122). The top arm 116 remains substantially parallel to the base 102 and to the top side 140 of the wall 103 throughout each of these movements.

In some examples, the top arm 116 is sealed. For example, the top arm 116 is hermetically sealed to prevent water from entering into the top arm 116 and to protect any wires housed therein. In some examples, the wires providing power and communications to the electronic equipment 118 extend along the inside of the top arm 116 and exit the top arm 116 at a proximal end portion, opposite the distal end portion 146. The apparatus 100 can include seals at the interface between the electronic equipment 118 and the distal end portion 146 and at the interface between wires of the electronic equipment at the proximal end portion.

The apparatus 100 is made of any suitable material. In one example, at least the base 102 and the arms of the apparatus 100 are made of a metal material, such as aluminum.

Electronic equipment 118 that can be mounted to the apparatus 100 includes, for example, video cameras, lidar scanners, motion detectors, speakers, unmanned aerial vehicles (“UAVs”), mounts for UAVs, launchpads for UAVs, or any combination thereof. In some embodiments, the electronic equipment 118 includes an electrical device.

In some embodiments, wiring of the electronic equipment 118 is threaded through one or more arms of the apparatus 100. For example, as shown in FIGS. 3A and 3B, the electronic equipment 118 attaches to the top arm 116. Wiring connected to the electronic equipment 118 enters the top arm 116 through the equipment-engagement feature 126 configured to receive the portion 120 of the electronic equipment 118 and/or through separate apertures in the top arm 116. In some embodiments, the wiring is only housed within the top arm 116 and not in any of the other parts of the apparatus 100.

Embodiments of the present disclosure also include methods for mounting electronic equipment 118 to barriers 101. Methods include attaching the equipment to a distal end portion 146 of the top arm 116. For example, the electronic equipment 118 is attached as shown in FIGS. 3A and 3B. However, embodiments of the present disclosure are not so limited. For example, the electronic equipment 118 can be mounted to the top arm 116 via other means, such as, for example, one or more of screws, magnets, adhesives, or any combination thereof. In some embodiments, the electronic equipment 118 is attached to the top arm 116 while the apparatus 100 is in a servicing position, such as the positions illustrated in FIGS. 1E and 2C. Hence, in some embodiments, the method includes mounting the base to a wall 103 (e.g., to the top side 140 of the wall 103) before securing the electronic equipment 118 to the top arm 116. In some embodiments, attaching the electronic equipment 118 to the top arm 116 also includes routing wires of the electronic equipment 118 through portions of the top arm 116.

The top arm 116 is rotated with respect to the middle arm 114 about the third axis 122 until the electronic equipment 118 is in position in a plane parallel to the top side 140 of the wall 103. Next, the top arm 116, middle arm 114, and electronic equipment 118 move in a plane substantially perpendicular to the top side 140 of the wall 103 via the pivot arm 104. The pivotal coupling between the pivot arm 104 and the base 102 allows the pivot arm 104 to move about the axis 121 perpendicular to the third axis 122 and helps to enable to the top arm 116, middle arm 114, and electronic equipment 118 to move in the plane substantially perpendicular to the top side 140. The top arm 116 and middle arm 114 move down towards the base 102 until the pivot arm 104 is substantially parallel to the base 102 and/or until the middle arm 114 contacts the base 102.

When the electronic equipment 118 is in place, the electronic equipment 118 extends below the base 102 and below the top side 140 of the wall 103b to which the base 102 is mounted, as shown in FIG. 1A.

Embodiments of the present disclosure include methods of servicing mounted electronic equipment 118. At the beginning of the method, the apparatus 100 is in a deployed position, as shown in FIGS. 1A and 2A. Methods of servicing electronic equipment 118 include moving the top arm 116 and the middle arm 114 in a first plane with respect to the base 102 of the apparatus 100 and the top side 140 of the wall 103b. The first plane is substantially perpendicular to the top side 140 of the wall 103b. Moving the top arm 116 and the middle arm 114 is done, for example, by rotating the pivot arm 104 with respect to the base 102 around the first axis 121 until the electronic equipment 118 is above the top side 140 of the wall 103b, as shown in FIG. 2B.

The method also includes rotating the top arm 116 with respect to the middle arm 114 about the third axis 122, which is substantially perpendicular to the first axis 121. For example, the top arm 116 is rotated approximately 90° with respect to the middle arm 114. The top arm 116 is rotated until the electronic equipment 118 has reached an interior 141 of the barrier 101, as shown in FIG. 2C, for example.

The method includes servicing the electronic equipment 118. Servicing the electronic equipment 118 includes at least one of: repairing, updating, checking, replacing, removing, or any combination thereof. After servicing the electronic equipment 118, the method includes returning the apparatus 100 to the deployed position, as shown in FIG. 1A. Returning the apparatus is accomplished, for example, by rotating the top arm 116 with respect to the middle arm 114. For example, the method includes applying torque to a distal end portion 146 of the top arm 116. Next, the method involves moving the top arm 116 and the middle arm 114 in a plane substantially parallel to the first axis 121 via the pivot arm 104 rotating with respect to the base 102. This is initiated, for example, by applying force down onto handle 128.

In some embodiments, once the apparatus 100 returns to the deployed position, fasteners 130c secure the apparatus 100 to the barrier 101 and/or the top arm 116 and middle arm 114 with respect to the base 102. For example, as shown in FIG. 1B, the base 102 includes receptacles 132 for receiving the fasteners 130c. In some examples, the top arm 116 is secured to the middle arm 114 through fasteners 130c. In some examples, the fasteners 130c are removable. If the fasteners 130c are in place prior to the electronic equipment 118 being serviced, the method includes removing the fasteners 130c prior to servicing the electronic equipment 118.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. An apparatus, comprising:
a base;
a first arm pivotally coupled to the base and pivotable with respect to the base about a first axis at a first end of the first arm;
a second arm pivotally coupled to the first arm at a second end of the first arm; and
a third arm rotatably coupled to the second arm and rotatable with respect to the second arm about a second axis substantially perpendicular to the first axis, the third arm comprising an equipment-engagement feature configured to receive electronic equipment.

2. The apparatus of claim 1, wherein the equipment-engagement feature of the third arm is positioned at a distal end portion of the third arm.

3. The apparatus of claim 1, wherein the second axis passes through a midpoint of second arm.

4. The apparatus of claim 1, wherein the electronic equipment comprises an electrical surveillance device.

5. The apparatus of claim 1, wherein the base comprises one or more slots configured to receive one or more mounting brackets and is configured to be secured to a wall via the one or more attachment members.

6. The apparatus of claim 1, wherein the second arm, the third arm, and the second end of the first arm are configured to move with respect to the base in a first plane.

7. The apparatus of claim 6, wherein the second arm, the third arm, and the second end of the first arm are configured to move with respect to the base in a second plane substantially perpendicular to the first plane.

8. The apparatus of claim 1, further comprising a fourth arm, wherein the fourth arm is:
substantially parallel to the first arm;
pivotally coupled to the base;
pivotable with respect to the base about a first axis at a first end of the fourth arm; and
coupled to the second arm at a second end of the fourth arm.

9. The apparatus of claim 1, further comprising a fifth arm, wherein the fifth arm is:
substantially parallel to the first arm;
pivotally coupled to the base;
pivotable with respect to the base about a first axis at a first end of the fifth arm; and
coupled to the second arm at a second end of the fifth arm.

10. The apparatus of claim 1, wherein a length of the second arm is less than a length of the third arm.

11. The apparatus of claim 1, wherein the base comprises a portion configured to receive the second arm.

12. The apparatus of claim 5, wherein the number of attachment members extend substantially perpendicular to the base in the first plane and are configured to attach to a wall.

13. The apparatus of claim 12, wherein the number of attachment members are attached to a first side of the base, the first side of the base being opposite to a second side of the base to which the first arm is pivotally coupled.

14. The apparatus of claim 12, the number of attachment members comprising a first attachment member configured to attach to a first wall segment and a second attachment member configured to attach to a second wall segment substantially perpendicular to the first wall segment.

15. A method of mounting electronic equipment to barriers, comprising:
attaching the electronic equipment to a distal end of a first arm;
rotating a first arm with respect to a second arm about a first axis; and
moving the first arm and the second arm in a first plane substantially parallel to the first axis via a third arm until the third arm is substantially parallel to a base, wherein the third arm is coupled to the second arm at a first end and pivotally coupled to the base at a second end.

16. The method of claim 15, wherein attaching the electronic equipment to the distal end of the first arm further comprises attaching the electronic equipment to an equipment-engagement feature positioned on a side of the first arm facing the second arm.

17. The method of claim 15, wherein attaching the electrical device to the distal end of the first arm further comprises rotating the electronic equipment about a second axis substantially parallel to the first axis.

18. The method of claim 15, wherein the electrical device extends below the base when the first arm is substantially parallel to the base.

19. The method of claim 15, further comprising attaching the base to a top of a wall segment.

20. A method of servicing mounted electronic equipment, comprising:
moving a top arm and a middle arm of an apparatus in a first plane with respect to a base of the apparatus by rotating a pivot arm of an apparatus with respect to a base of the apparatus around a first axis until the electronic equipment is above of a top side of a barrier to which the base is attached, wherein the first plane is substantially perpendicular to the top side of the barrier; and
rotating the top arm with respect to the middle arm about a second axis substantially perpendicular to the first axis.
